(19) United States
(12) Patent Application Publication
(10) Pub. No.: US 2021/0241298 A1
(43) Pub. Date: Aug. 5, 2021

(54) MAINTAINING AN UP-TO-DATE PRODUCT DATABASE BASED ON FORECAST AND HISTORICAL DATA

(71) Applicant: Capital One Services, LLC, McLean, VA (US)

(72) Inventors: Lokesh Vijay KUMAR, Frisco, TX (US); Poornima Bagare RAJU, Frisco, TX (US)

(73) Assignee: Capital One Services, LLC, McLean, VA (US)

(21) Appl. No.: 16/776,908

(22) Filed: Jan. 30, 2020

(51) Int. Cl. G06Q 30/02; G06Q 30/06

(52) U.S. Cl. CPC G06Q 30/0205; G06Q 30/0641; G06Q 30/0206; G06Q 30/0627; G06Q 30/0201

(57) ABSTRACT

Disclosed herein are system, method, and computer program product embodiments for maintaining an up-to-date product database. Upon receipt of a description of an event forecasted to occur in a geographic region, one or more sellers in the geographic region may be identified. Upon identification of the one or more sellers in the geographic region, online information of one or more products that are offered for sale may be accessed, and compared with information from the product database for the one or more products. Based on the comparison, a product of the one or more products having a first value for a characteristic of the product in the product database that is different from a second value for the characteristic of the product in the accessed online information may be identified, and the product database may be updated to change the characteristic of the product to the second value.

### BACKGROUND

A platform may be offered to search and compare items for purchase, such as vehicles, from a website that aggregates inventory from across a plurality of sellers. To maintain the platform, the information available on the website should remain accurate. For example, it should correspond to actual prices offered by the sellers. This may be particularly important for a financial institution that may be associated with the website to enable the financial institution to provide accurate financing information for each of the items in the inventory. When a discrepancy is found, for example, when a price shown for a particular vehicle on the website differs from a price shown on a website of the seller, a financial institution is unable to provide accurate financing information for the particular vehicle and the platform's credibility may be damaged. For example, a customer may lose trust in the platform as a trusted source of information and may not be able to accurately identify items in the inventory that meet the customer's preferences, e.g., a monthly payment amount for financing a vehicle.

A vehicle's price may change when the seller holds a sale. When the sale occurs, a database supporting the website may become outdated.

Some of these platforms may offer a comparison of hundreds of thousands of items across thousands of sellers across the nation. Given the volume of data, keeping the inventory database supporting the website up-to-date becomes a considerable challenge due to a large amount of data that is required to be processed.

Methods and systems are required to keep inventory pricing databases up-to-date more efficiently.

### BRIEF DESCRIPTION OF THE DRAWINGS/FIGURES

The accompanying drawings are incorporated herein and form a part of the specification.

FIG. 1 illustrates an example of a comparison showing a price difference for an item on a platform website and a website of a seller.

FIG. 2 is an example system that provides trigger information to determine sellers and products for maintaining an up-to-date product database, according to some embodiments.

FIG. 3 is an example system for maintaining an up-to-date product database, according to some embodiments.

FIG. 4 is a flowchart illustrating a method for maintaining an up-to-date product database, according to some embodiments.

FIG. 5 illustrates an example computer system, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Embodiments maintain an up-to-date product or inventory database. In one embodiment, a method is disclosed that maintains up-to-date product information. The method includes receiving a description of an event forecasted to occur in a geographic region. Based on the forecasted event, one or more sellers in the geographic region are identified. Online information of the one or more sellers is accessed to retrieve one or more products that the sellers have in inventory and/or offered for sale. The accessed online information is compared to corresponding information from the product database for the one or more products. Based on the comparison, a product is identified, and information for the product is updated in the product database.

Method and computer program product embodiments are also disclosed.

Various embodiments of this disclosure will be discussed with respect to the corresponding figures.

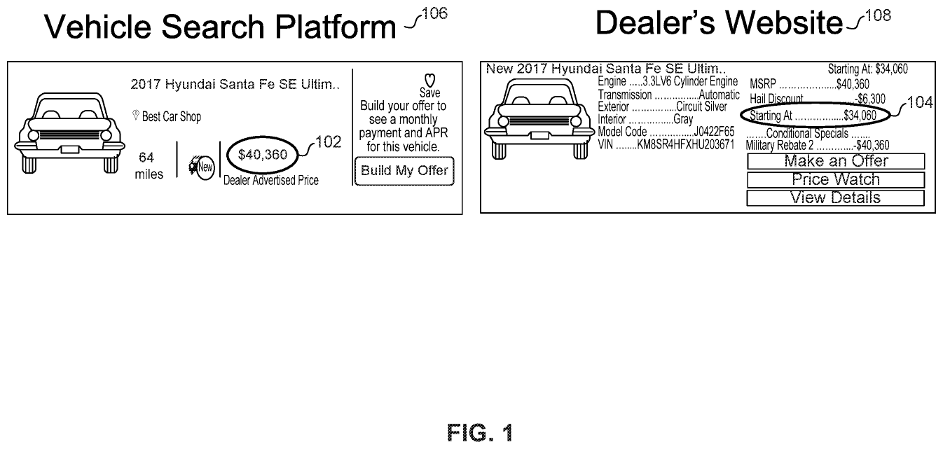

FIG. 1 illustrates an example of a comparison showing a price difference for an item on a website of a financial institution and a website of a seller. Various embodiments are described using a website of a financial institution as the financial institution may provide financing for vehicle purchased with many different auto dealers. Thus, it is required that the pricing information on the website of the financial institution is accurate so the customer can compare pricing of a vehicle at various dealers using a single website. Therefore, the single website does not have to be a website of a financial institution, rather the single website can be a website of an aggregator of a plurality of third party vendors, for example, auto dealers, where the website has to provide accurate information collected from the plurality of third party vendors. As shown in FIG. 1, a vehicle search platform 106 is a financial institution's website that allows a customer to search for classes of vehicles, or by other search criteria, for example, vehicle price, and/or monthly payment, etc., and compare the price or monthly payment of the particular vehicles at thousands of participating dealers across the nation. Therefore, as a single website providing search and comparison of a plurality of vehicles without requiring the customer to visit websites of a plurality of car dealers, the financial institution's website is required to show the price for the vehicle as shown on the websites of the plurality of car dealers for the vehicle, particularly as it may relate to enabling a customer to search or filter the vehicles based on price or a monthly payment that be determined based on real financing terms offered by the financial institution for each particular vehicle.

As shown in FIG. 1, for a particular 2017 Hyundai Santa Fe, the vehicle search platform 106 shows price 102 of $40,360, while for the same 2017 Hyundai Santa Fe, a car dealer's website 108 shows price 104 of $34,060. Accordingly, there is a substantial price gap between the two prices for the vehicle. Such price discrepancies prevents the vehicle search platform 106 from providing accurate up to date information of the available third party inventory that may cause inaccurate search results and dissatisfaction to the customer.

The price discrepancy may occur for various reasons, for example, the car dealer may have a sales event, and so the car dealer's website may have updated prices for a plurality of vehicles being sold by the car dealer. However, the updated prices may not be coordinated with the website provider such that there is no price discrepancy. The car dealer may have a sales event due to a forecasted weather event that suggests damage to the unsold vehicles on the lot. Therefore, to reduce liability and loss from an anticipated damage to the unsold vehicle, the car dealer may have a sales event to sell the vehicles at reduced prices. The car dealer may have a sales event over the holidays, for example, Memorial Day, Labor Day, Thanksgiving week, Christmas week, etc. Therefore, if it can be determined that a particular car dealer may have a sales event because of the forecasted weather event, or over the holidays, the financial institution can access the website of the particular car dealer and update one or more vehicles' prices in a database that supports the financial institution's website.

Since the plurality of car dealers that may have partnered with the financial institution may be in the thousands, and each car dealer may have again a total number of vehicles in the thousands, keeping the price up-to-date for each vehicle for sale at each car dealer at the database that supports the financial institution's website may require significant computing power and time. However, as described herein, the price for each vehicle for sale at each car dealer may be kept up-to-date at the database that supports the financial institution's website if the update is limited to a few car dealers. As described above, the car dealer may have a sales event in anticipation of damage to the vehicles based on the forecasted weather event. The car dealer may also have a sales event in anticipation of damage to the vehicles based on historical weather pattern in the geographic region. For example, a hailstorm has always occurred every year, for past ten years, even though a hailstorm is not yet forecasted the car dealer may prefer to reduce liability and loss by reducing his inventory through a sales event. Thus, by receiving weather forecast event for a geographic region, and based on the weather forecast event, and identifying one or more car dealers that may have a sales event may reduce the total number of car dealers whose websites are required to be accessed for the updated prices of the vehicles being sold.

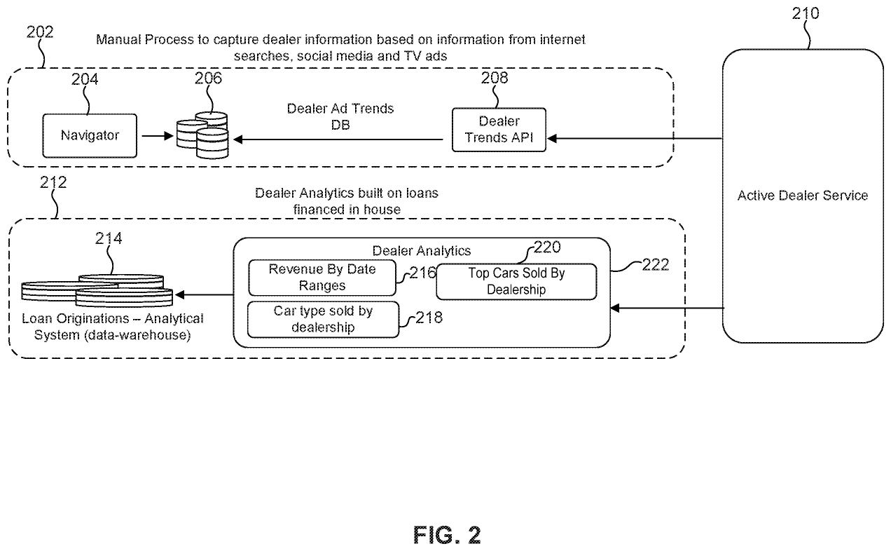

FIG. 2 is an example system that provides trigger information to determine sellers and products for maintaining an up-to-date product database, according to some embodiments. As shown in FIG. 2, in some embodiments, one section 202 may receive car dealer information via a dealer trend application programming interface (API) 208 from active car dealer service 210 and stores in one or more databases 206. The car dealer service 210 provides information about active car dealers based on a plurality of filtering criteria. The filtering criteria may be a dealer name, a city, a state, a county, and/or a country in which the dealer is located. By way of non-limiting example, the dealer trend API 208 may receive the car dealer information from the car dealer service 210 via web service message(s) implemented using simple object access protocol (SOAP), representational state transfer (REST), and/or javascript object notation web-service protocol (JSON-WSP), etc. The dealer trend API 208 may provide secured or unsecured communication with the car dealer service 210. A navigator 204 may retrieve from the one or more databases 206 information about the car dealer including name and address information of the car dealer, holidays and/or patterns when the car dealer had sales events, current sales events, and/or sales events occurring over a specified threshold time period, for example, days, weeks, and/or months, etc. The navigator 204 may be implemented as software, hardware, or firmware module. The car dealer service 210 may determine information of the holidays and/or the patterns when the car dealer had sales events, the current sales events, and/or the sales events occurring over the specified threshold time period based on advertisements of the sales event on social media, online media, television, and/or radio, etc.

As shown in FIG. 2, in some embodiments, another section 212 may receive car dealer analytics based on loans financed by the financial institution via an application programming interface (API) from the car dealer service 210. The car dealer analytics 222 may include, for example, revenue from vehicles sold for a specific date range 216, vehicle types sold by the car dealer 218, and/or top vehicles sold by the car dealer 220. The vehicle types sold by the car dealer 218 and/or the top vehicles sold by the car dealer 220 may be for the specific date range. The car dealer analytics 222 is then stored in one or more databases 214. The car analytics 222 may be used to identify a pattern when the car dealer previously held a sales event based on the prices of the vehicles sold over different date ranges. The car analytics 222 may also be used to identify vehicle makes and models that are offered at a discounted price during the sales event. Accordingly, as described above, identifying the car dealer that held a sales event, types of vehicles that were offered at discounted price during the sales event, and/or a pattern when the car dealer held a sales event may help to predict a car dealer that may also have a sales event that also matches the identified pattern.

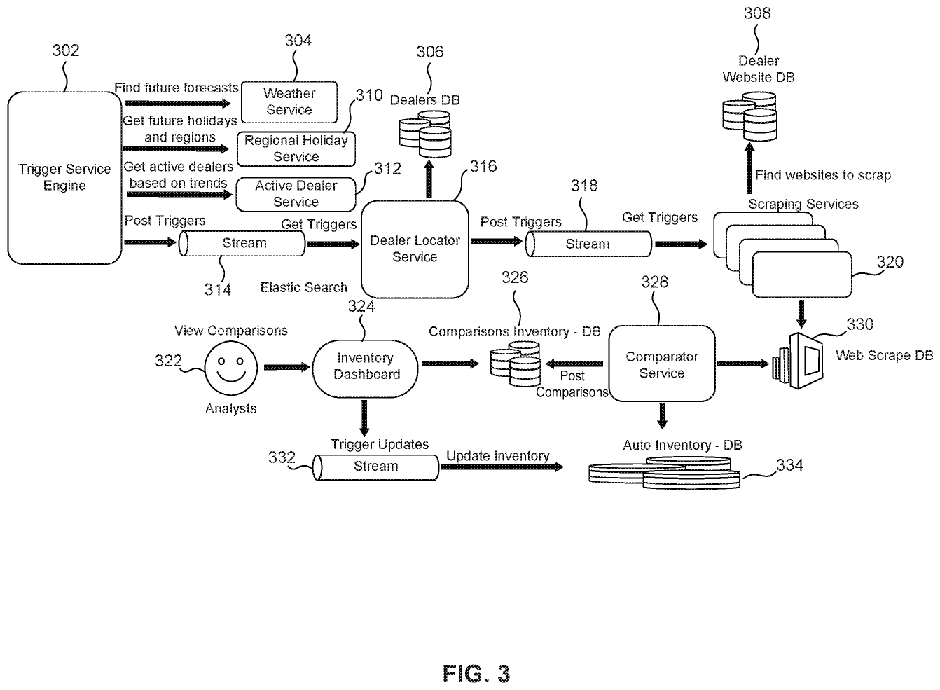

FIG. 3 is an example system for maintaining an up-to-date product database, according to some embodiments. As shown in FIG. 3, the system includes a trigger service engine 302 that may ingest one or more relevant information streams for predicting events or timing that may impact accuracy of third party product or inventory information in a product database and triggers selective retrieval of up to date information from particular third party vendors.

The trigger service engine 302 may receive weather forecast information from a weather service 304, and upcoming holiday information from a regional holiday service 310. weather forecast information and the upcoming holiday information may be specific to a geographic region. The geographic region may be identified by a city, a state, a county, a country, and/or a zip code. By way of non-limiting example, the trigger service engine 302 may pull the weather forecast information and the upcoming holiday information from the weather service 304 and the regional holiday service 310 respectively using a corresponding application programming interface (API) message(s). The weather service 304 and the regional holiday service 310 may also push the weather forecast information and the upcoming holiday information to the trigger service engine 302 using a corresponding API message(s).

The API message(s) for pulling the weather forecast information and the upcoming holiday information, and the API message(s) for pushing the weather forecast information and the upcoming holiday information may be a web service message(s) implemented over SOAP, REST, JSON-WSP, or like of it. The weather forecast information and the upcoming holiday information may be communicated with the trigger service engine 302 over a secure or an unsecure interface.

The trigger service engine 302 may receive active dealer trends from an active dealer service 312 as described in detail with reference to FIG. 2 above. Based on the received weather forecast information, the upcoming holiday information, a car dealer that held a sales event, type of the vehicles that were offered at discounted price during the sales event, and/or a pattern when the car dealer held the sales event, the trigger service engine 302 may identify a geographic region in which one or more car dealers may hold a sales event. The trigger service engine may also identify the one or more car dealers that may hold a sales event.

The trigger service engine 302 may post triggers via a stream 314 to a dealer locator service 316. By way of non-limiting example, the stream 314 may be an API as described above. The trigger may include the geographic region in which the one or more car dealers may hold a sales event. The trigger may also include the one or more car dealers that may hold a sales event. The dealer locator service 316 may access a dealer database 306 that stores car dealer information. The car dealer information, for example, may include a car dealer business name, a business address of the car dealer, a website address of the car dealer, etc. The dealer locator service 316 may query the dealer database 306 to prepare a list of car dealers with the corresponding car dealer information that are in the geographic region specified in the trigger. The dealer locator service 316 may then post the prepared list of car dealers with the corresponding car dealer information to a scraping service 320 via a stream 318. By way of non-limiting example, the dealer locator service 316 may also include a list of vehicle types for which the car dealer may hold a sales event in the car dealer information. By way of non-limiting example, the stream 318 may be similar to the stream 314.

Upon receipt of the information from the dealer locator service, the scraping service 320 may access a website of the car dealer based on the website address of the car dealer specified in the car dealer information. The scraping service may access the website of the car dealer to receive current information of the vehicles being sold by the car dealer that is saved at dealer website database 308. The current information may include vehicle model, make, year of manufacture, manufacture suggested retail price, a sale price of the vehicle, and/or a time period for which the sale price of the vehicle is valid, etc. By way of non-limiting example, the scraping service may access the website of the car dealer and fetch a plurality of webpages to determine current information of the vehicle types specified in the car dealer information.

The scraping service 320 may parse the plurality of webpages, and identify a plurality of fields and corresponding values of the plurality of fields. The scraping service 320 may parse the plurality of webpages via text pattern matching, hypertext markup language parsing, document object model parsing, metadata extraction, and/or optical character recognition (OCR), etc. The plurality of fields may include the vehicle model, the make, the year of manufacture, the manufacture suggested retail price, the sale price of the vehicle, and/or the time period for which the sale price of the vehicle is valid, date and time when a webpage of the plurality of webpages was last updated and/or fetched, etc. The scraping service 320 may store the plurality of fields and the corresponding values of the plurality of fields into a web scrape database 330.

A comparator service 328 may compare new or updated data from the web scrape database 330 with the data stored in auto inventory database 334. The comparator service may identify a car dealer, vehicle make, vehicle model, vehicle year, and other associated fields and corresponding values that are entered or updated in the web scrape database 330 since a specified time period, for example, in the last 24 hours, last week, a date range, etc., and compare with corresponding data records in the auto inventory database 334. Based on the comparison, the comparator service 328 may identify a plurality of records stored in the auto inventory database 334 as having a different value for one or more fields of the corresponding data records from the web scrape database 330, and store the identified plurality of records stored in the auto inventory database 334 and the corresponding data records from the web scrape database 330 into comparisons inventory database 326.

An update service may periodically access the comparisons inventory database 326, and identify which field(s) is having a different value for a vehicle between the web scrape database 330 and the auto inventory database 334. By way of non-limiting example, the update service may access the comparisons inventory database 326 based on a trigger from the comparator service 328. The update service then updates the record stored in the auto inventory database 334 corresponding to the vehicle based on the data record stored in the web scrape database 330 for the vehicle. By way of non-limiting example, the update service may add, update, delete, and/or replace value of any field of the data record stored in the auto inventory database 334, which may include vehicle model, the make, the year of manufacture, the manufacture suggested retail price, the sale price of the vehicle, and/or the time period for which the sale price of the vehicle is valid, etc.

By way of non-limiting example, an inventory dashboard 324 may show data based on the data stored in the comparisons inventory database 326. As described above, data stored in the comparisons inventory database 326 corresponds to the vehicle for which data stored in the web scrape database 330 and the auto inventory database 334 is different. An operator 322 of the inventory dashboard 324 may review the shown data and may trigger an addition, update, deletion, and/or replacement of value of any field of the data record stored in the auto inventory database 334 via a stream 332. Various fields of the data record may include the vehicle model, make, year of manufacture, manufacture suggested retail price, the sale price of the vehicle, and/or the time period for which the sale price of the vehicle is valid, etc.

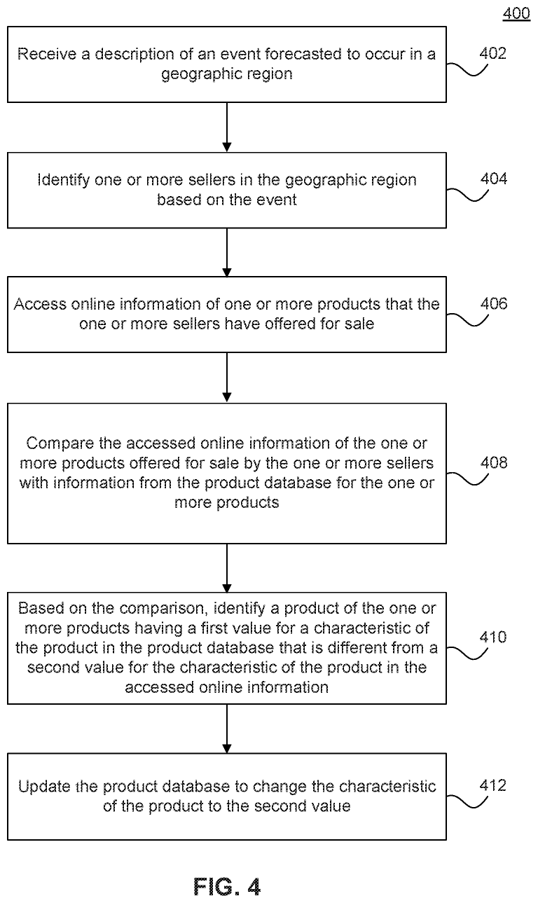

FIG. 4 is a flowchart illustrating a method for maintaining an up-to-date product database, according to some embodiments.

As shown in FIG. 4, at step 402, the trigger service engine 302 receives a description of an event forecasted to occur in a geographic region. By way of non-limiting example, the event may be related to a weather condition. The description of the event may include weather forecast information or historical weather information corresponding to the geographic region. The geographic region may be identified by a city, a state, a county, a country, and/or a zip code. The event may be related to a holiday, and the description of the event may include sale information or historical sale information corresponding to the geographic region. The sale information or historical sale information may be obtained from online media, social networking websites, television, and/or radio, etc. as described above.

At step 404, the trigger service engine 302 identifies one or more sellers in the geographic region based on the description of the event received at step 402. The trigger service engine may identify the one or more sellers in the geographic region that may hold a sales event for the reasons described in this disclosure. The reasons for the sales event may be to reduce liability or loss from an anticipated damage based on the forecasted weather event, such as, hailstorm, tornado, and/or hurricane, etc. The reasons for the sales event may be related to holidays being observed in the geographic region during which the car dealer may historically had sales events or may likely have a sales event. By way of non-limiting example, the one ore more sellers may be identified based on historical information that includes an advertisement trend, and/or a sale trend. The trigger service engine 302 triggers the dealer locator service 316 to transmit a query message(s) to a server requesting a set of sellers in the geographic region, and receive a query response message(s) that includes set of the sellers in the geographic region. The server may include the dealer database 306.

At step 406, the scraping service 320 accesses online information of one or more products that the one or more sellers have offered for sale. As described above, the scraping service 320 may fetch a plurality of webpages or other online information available for the one or more sellers and/or the one or more products that the one or more sellers have offered for sale.

To fetch the plurality of webpages or the other online information, the scraping service 320 may establish a session with an application server or a web server of the one or more sellers. The session may be a secure or an unsecure session established using hypertext transfer protocol (HTTP), and/or transmission control protocol (TCP), etc. The scraping service 320 may exchange a request and/or a response message(s) with the server over the established session. The scraping service may then parse received online information of the one or more products, as described above, for comparison with the information from the product database.

At step 408, the comparator service compares the accessed online information of the one or more products offered for sale by the one or more sellers that are stored in the web scrape database 330 with information from the auto inventory database 334 for the one or more products. The auto inventory database 334 may be a product database. At step 410, based on the comparison, the comparator service 328 may identify a product of the one or more products having a first value for a characteristic of the product in the product database that is different from a second value for the characteristic of the product in the accessed online information. The characteristic of the product may be a price of the product.

At step 412, by way of non-limiting example, an update service may update the product database to change the characteristic of the product to the second value. As described above, the product database may be the auto inventory database 334, and the characteristic of the product may be a price of the product.

While the embodiments are described with reference to car/vehicle dealer and car sales event, the embodiments may be practiced for a sale for any kind of product and/or service.

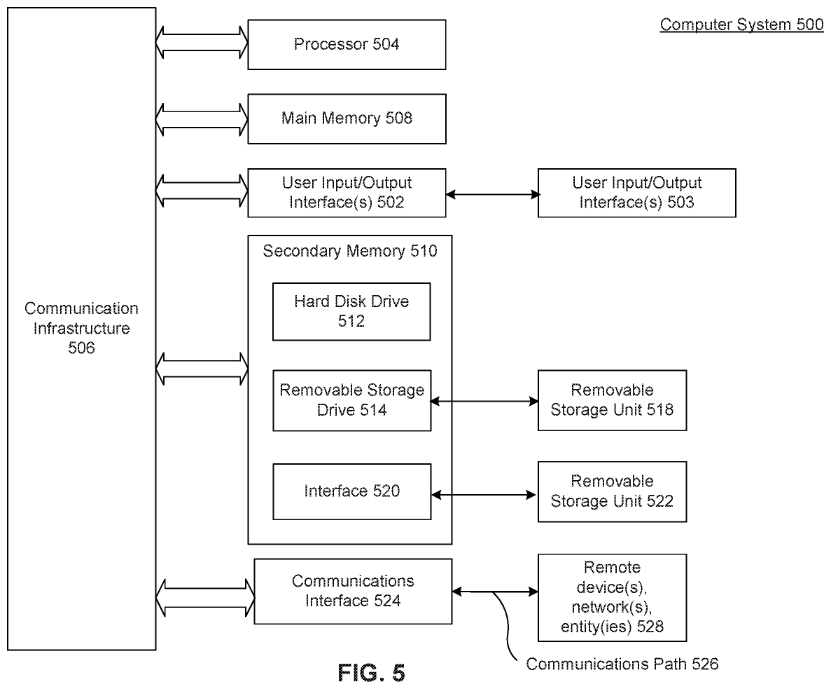

FIG. 5 illustrates an example computer system, in accordance with some embodiments.

Various embodiments may be implemented, for example, using one or more well-known computer systems, such as a computer system 500, as shown in FIG. 5. One or more computer systems 500 may be used, for example, to implement any of the embodiments discussed herein, as well as combinations and sub-combinations thereof. The computer systems 500 may be used for implementation of one or more embodiments described above.

The computer system 500 may include one or more processors (also called central processing units, or CPUs), such as a processor 504. The processor 504 may be connected to a communication infrastructure or bus 506.

The computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

The computer system 500 may also include a main or primary memory 508, such as random access memory (RAM). Main memory 508 may include one or more levels of cache. Main memory 508 may have stored therein control logic (i.e., computer software) and/or data.

The computer system 500 may also include one or more secondary storage devices or memory 510. The secondary memory 510 may include, for example, a hard disk drive 512 and/or a removable storage device or drive 514. The removable storage drive 514 may be a floppy disk drive, a magnetic tape drive, a compact disk drive, an optical storage device, tape backup device, and/or any other storage device or storage drive.

The removable storage drive 514 may interact with a removable storage unit 518. The removable storage unit 518 may include a computer usable or readable storage device having stored thereon computer software (control logic) and/or data. The removable storage unit 518 may be a floppy disk, magnetic tape, compact disk, DVD, optical storage disk, and/any other computer data storage device. The removable storage drive 514 may read from and/or write to the removable storage unit 518.

The secondary memory 510 may include other means, devices, components, instrumentalities or other approaches for allowing computer programs and/or other instructions and/or data to be accessed by the computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

The computer system 500 may further include a communication or network interface 524. The communication interface 524 may enable the computer system 500 to communicate and interact with any combination of external devices, external networks, external entities, etc. (individually and collectively referenced by reference number 528). For example, the communication interface 524 may allow the computer system 500 to communicate with the external or remote devices 528 over communications path 526, which may be wired and/or wireless (or a combination thereof), and which may include any combination of LANs, WANs, the Internet, etc. Control logic and/or data may be transmitted to and from the computer system 500 via the communication path 526.

The computer system 500 may also be any of a personal digital assistant (PDA), desktop workstation, laptop or notebook computer, netbook, tablet, smartphone, smartwatch or other wearable, appliance, part of the Internet-of-Things, and/or embedded system, to name a few non-limiting examples, or any combination thereof.

The computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in the computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, or schemas may be used, either exclusively or in combination with known or open standards.

In accordance with some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, the computer system 500, the main memory 508, the secondary memory 510, and the removable storage units 518 and 522, as well as tangible articles of manufacture embodying any combination of the foregoing. Such control logic, when executed by one or more data processing devices (such as the computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments but should be defined only in accordance with the following claims and their equivalents.

1. A method for maintaining an up-to-date product database, the method comprising:
receiving, by one or more computing devices, a description of an event comprising at least one of weather forecast information or historical weather information corresponding to a geographic region;
identifying, by the one or more computing devices, a set of sellers that are located in the geographic region corresponding to the description of the event;
based on historical information corresponding to the set of sellers and scraped from a web site of each seller of the set of sellers, selecting, by the one or more computing devices, one or more sellers from the set of sellers as being likely to offer a sale based on the description of the event;
based on the historical information, scraping, by the one or more computing devices, online information of one or more products that the selected one or more sellers have offered for sale using a webpage parsing technique;
comparing, by the one or more computing devices, the accessed online information of the one or more products offered for sale by the one or more sellers with information from the product database for the one or more products;
identifying, based on the comparison by the one or more computing devices, a product of the one or more products having a first value for a characteristic of the product in the product database that is different from a second value for the characteristic of the product in the accessed online information to update the product database to change the characteristic of the product to the second value; and
displaying the product and the second value for the characteristic of the product on a display screen.

2. (canceled)

3. The method of claim 1, wherein the geographic region is identified by any one of a city, a state, a county, a country, or a zipcode.

4. The method of claim 1, wherein the identifying the set of sellers in the geographic region comprises:
transmitting, by the one or more computing devices, a query message to a server requesting the set of sellers in the geographic region; and
in response to the query message, receiving, by the one or more computing devices, a response message that comprises the set of the sellers in the geographic region.

5. The method of claim 1, wherein the historical information comprises at least one of an advertisement trend and a sale trend.

6. The method of claim 1, wherein the accessing the online information comprises:
establishing, by the one or more computing devices, a session with an application server provided by the one or more sellers;
exchanging, by the one or more computing devices, a request message and a response message to receive the online information of the one or more products; and
parsing, by the one more computing devices, the received online information of the one or more products for comparison with the information from the product database.

7. The method of claim 1, wherein the characteristic of the product is a price of the product.

8. The method of claim 1, wherein the description of the event further comprises a holiday information, the method further comprising:
receiving, by the one or more computing devices, sale information or historical sale information corresponding to the geographic region.

9. A system for maintaining an up-to-date product database, the system comprising:
a memory configured to store operations; and
one or more processors configured to perform the operations, the operations comprising:
receiving a description of an event comprising at least one of weather forecast information or historical weather information corresponding to a geographic region;
identifying a set of sellers that are located in the geographic region where corresponding to the description of the event;
based on historical information corresponding to the set of sellers and scraped from a web site of each seller of the set of sellers, selecting one or more sellers from the set of sellers as being likely to offer a sale based on the description of the event;
based on the historical information, scraping online information of one or more products that the selected one or more sellers have offered for sale using a webpage parsing technique;
comparing the accessed online information of the one or more products offered for sale by the one or more sellers with information from the product database for the one or more products;
based on the comparison, identifying a product of the one or more products having a first value for a characteristic of the product in the product database that is different from a second value for the characteristic of the product in the accessed online information to update the product database to change the characteristic of the product to the second value; and
displaying the product, and the second value for the characteristic of the product on a display screen.

10. (canceled)

11. The system of claim 9, wherein the geographic region is identified by any one of a city, a state, a county, a country, or a zipcode.

12. The system of claim 9, wherein for the identifying the set of sellers in the geographic region, the operations further comprise:
transmitting a query message to a server requesting the set of sellers in the geographic region; and
in response to the query message, receiving a response message that comprises the set of the sellers in the geographic region.

13. The system of claim 9, wherein the historical information comprises at least one of an advertisement trend and a sale trend.

14. The system of claim 9, wherein for the accessing the online information, the operations further comprise:
establishing a session with an application server provided by the one or more sellers;
exchanging a request message and a response message to receive the online information of the one or more products; and
parsing the received online information of the one or more products for comparison with the information from the product database.

15. The system of claim 9, wherein the characteristic of the product is a price of the product.

16. The system of claim 9, wherein the description of the event further comprises a holiday information, and wherein the operations further comprise:
receiving sale information or historical sale information corresponding to the geographic region.

17. A non-transitory, tangible computer-readable device having instructions stored thereon that, when executed by at least one computing device, causes the at least one computing device to perform operations comprising:
receiving a description of an event comprising at least one of weather forecast information or historical weather information corresponding to a geographic region;
identifying a set of sellers that are located in the geographic region where corresponding to the description of the event;
based on historical information corresponding to the set of sellers and scraped from a website of each seller of the set of sellers, selecting one or more sellers from the set of sellers as being likely to offer a sale based on the description of the event;
based on the historical information, scraping online information of one or more products that the selected one or more sellers have offered for sale using a webpage parsing technique;
comparing the accessed online information of the one or more products offered for sale by the one or more sellers with information from the product database for the one or more products;
based on the comparison, identifying a product of the one or more products having a first value for a characteristic of the product in the product database that is different from a second value for the characteristic of the product in the accessed online information to update the product database to change the characteristic of the product to the second value; and
displaying the product, and the second value for the characteristic of the product on a display screen.

18. (canceled)

19. The non-transitory, tangible computer-readable device of claim 17, wherein the description of the event comprises a holiday information, and wherein the operations further comprise receiving sale information or historical sale information corresponding to the geographic region.

20. The non-transitory, tangible computer-readable device of claim 17, wherein the characteristic of the product is a price of the product.

21. The method of claim 1, wherein the webpage parsing technique comprises one of a text pattern matching, hypertext markup language (HTML) parsing, a document object model (DOM) parsing, metadata extraction, and an optical character recognition (OCR).

22. The method of claim 1, wherein the scraping online information of the one or more products is performed based on a pattern of the selected one or more sellers identifying when the one selected one or more sellers held a sales event.

23. The method of claim 22, wherein the pattern is identified based on a price of the one or more products sold over a predetermined time period.
